(19) United States
(12) Patent Application Publication
(10) Pub. No.: US 2026/0236057 A1
(43) Pub. Date: Aug. 13, 2026

(54) PRESSURE PEDAL ASSEMBLY

(71) Applicant: KSR IP Holdings, LLC, Wilmington, DE (US)

(72) Inventors: Marty Vanek, Thamesville (CA); Joong Lee, Toronto (CA)

(73) Assignee: KSR IP Holdings, LLC, Wilmington, DE (US)

(21) Appl. No.: 19/538,130

(22) Filed: Feb. 12, 2026

Related U.S. Application Data
(60) Provisional application No. 63/757,941, filed on Feb. 13, 2025.

(51) Int. Cl. G05G 1/38; B60T 7/06; G05G 1/50

(52) U.S. Cl. CPC G05G 1/38; B60T 7/06; G05G 1/506

(57) ABSTRACT

Embodiments herein are directed to a pedal assembly that includes a housing, a pedal member movably positioned within the housing, and a sensing assembly positioned within the housing. The sensing assembly includes an inductive plate having a pair of arms connected by a base, and a printed wiring assembly positioned at least partially within an opening between the pair of arms. The printed wiring assembly is spaced apart from the pair of arms by a predetermined distance and is configured to generate an inductance between the printed wiring assembly and the inductive plate. When a load is applied on the pedal, the predetermined distance between each of the pair of arms changes based on an amount of the load applied, causing a change in the inductance based on the amount of the load applied to the pedal member that is sensed by the sensing assembly.

### CROSS-REFERENCE TO RELATED APPLICATIONS

This utility patent application claims priority benefit from U.S. Provisional Patent Application Serial No. 63/757,941, filed Feb. 13, 2025, and entitled “Force Transducer Pressure Pedal Assembly with Wake-Up Switch”, the entire contents of which is incorporated by reference herein in its entirety.

### TECHNICAL FIELD

The present specification generally relates to pedal assemblies for vehicles and, more specifically, to pedal assemblies utilizing force transducer assemblies.

### BACKGROUND

Conventional pedal assemblies include a pedal arm that is pivotally coupled to a housing at one end and a pedal pad positioned on an opposite end. In these pedal assemblies, various inductive or Hall Effect type sensors are positioned within the housing to measure the amount of pivot of the pedal arm with respect to a target. When a force is applied to the pedal pad, the pedal arm pivots and, based on the amount of pivot, generally electric motors control the vehicle accordingly. However, in floor mounted pedal pads, a user may not apply the same pressure or load over the entire pedal pad. As such, load balancing and measuring small amount of travel of the pedal arm are issues. Accordingly, there is a need for pedal assemblies that have load balancing and measure minimal force and/or travel of the pedal pad.

### SUMMARY

In one embodiment, a pedal assembly is provided. The pedal assembly includes a housing, a pedal member movably positioned within the housing, and a sensing assembly positioned within the housing. The sensing assembly includes an inductive plate having a pair of arms connected by a base forming a "U" shape in cross-section and a printed wiring assembly positioned at least partially within an opening between the pair of arms. The printed wiring assembly is spaced apart from the pair of arms by a predetermined distance and is configured to generate an inductance between the printed wiring assembly and the inductive plate. When a load is applied on the pedal member, the predetermined distance between each of the pair of arms changes based on an amount of the load applied, causing a change in the inductance based on the amount of the load applied to the pedal member that is sensed by the sensing assembly.

In another embodiment, a pedal assembly is provided. The pedal assembly includes a housing, a pedal member having an elongated slot and movably positioned within the housing, and a sensing assembly positioned within the housing. The sensing assembly includes an inductive plate, a printed wiring assembly, a target, and a sensor. The inductive plate includes a pair of arms connected by a base forming a "U" shape. The inductive plate is positioned within the elongated slot of the pedal member. The printed wiring assembly is positioned at least partially within an opening between the pair of arms and partially within the elongated slot of the pedal member. The printed wiring assembly is spaced apart from the pair of arms by a predetermined distance and configured to generate an inductance between the printed wiring assembly and the inductive plate. The target is positioned within the housing at a target predetermined distance from the printed wiring assembly. The sensor is communicatively coupled to the printed wiring assembly and configured to detect a change in the target predetermined distance. When a load is applied on the pedal member, the predetermined distance between each of the pair of arms changes based on an amount of the load applied, causing a change in the inductance based on the amount of the load applied to the pedal member sensed by the sensing assembly and the target predetermined distance changes causing the sensor to either output a change signal or stop transmitting a signal.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective side view of an example pedal assembly according to one or more embodiments shown and described herein;

FIG. 2 schematically depicts a partially exploded perspective view of the example pedal assembly of FIG. 1 according to one or more embodiments shown and described herein;

FIG. 3A schematically depicts an isolated perspective top view of a bottom housing member of a housing of the example pedal assembly of FIG. 2, according to one or more embodiments shown and described herein;

FIG. 3B schematically depicts an isolated perspective top view of an upper housing member of the housing of the example pedal assembly of FIG. 2, according to one or more embodiments shown and described herein;

FIG. 3C schematically depicts an isolated plan top view of a plate member of the housing of the example pedal assembly of FIG. 2, according to one or more embodiments shown and described herein;

FIG. 3D schematically depicts an isolated plan bottom view of a pedal member of the example pedal assembly of FIG. 2, according to one or more embodiments shown and described herein;

FIG. 3E schematically depicts an isolated perspective side view of the pedal member of the example pedal assembly of FIG. 3D, according to one or more embodiments shown and described herein;

FIG. 3F schematically depicts an isolated perspective top view of a linear bushing of the example pedal assembly of FIG. 2, according to one or more embodiments shown and described herein;

FIG. 4A schematically depicts cross sectional view of the example pedal assembly of FIG. 1 taken from line 4-4 depicting the example pedal assembly in a no load applied to the pedal member state, according to one or more embodiments shown and described herein;

FIG. 4B schematically depicts cross sectional view of the example pedal assembly of FIG. 4A depicting the example pedal assembly in a load applied to the pedal member state, according to one or more embodiments shown and described herein;

FIG. 5A schematically depicts an isolated plan view of an example printed wiring assembly and an example inductive plate in a no load applied state, according to one or more embodiments shown and described herein;

FIG. 5B schematically depicts an isolated plan view of the example printed wiring assembly and the example inductive plate of FIG. 5A in a load applied state, according to one or more embodiments shown and described herein;

FIG. 6A schematically depicts an isolated plan view of an example printed wiring assembly for a wake-up switch and an example target in a no load applied state, according to one or more embodiments shown and described herein;

FIG. 6B schematically depicts an isolated plan view of the example printed wiring assembly for the wake-up switch and the example target of FIG. 6A in a load applied state, according to one or more embodiments shown and described herein;

FIG. 7A schematically depicts an isolated plan view of an second example printed wiring assembly for the wake-up switch in a no load applied state, according to one or more embodiments shown and described herein;

FIG. 7B schematically depicts an isolated plan view of the second example printed wiring assembly for the wake-up switch of FIG. 7A in a load applied state, according to one or more embodiments shown and described herein;

FIG. 8A schematically depicts an isolated plan view of a third example printed wiring assembly for a wake-up switch in a no load applied state, according to one or more embodiments shown and described herein; and

FIG. 8B schematically depicts an isolated plan view of the example printed wiring assembly for the wake-up switch of FIG. 8A in a load applied state, according to one or more embodiments shown and described herein.

### DETAILED DESCRIPTION

Embodiments described herein are directed to pedal assemblies that are configured for minimal travel pedal applications by measuring a change in inductance indicative of a force or load applied to a pedal pad. The pedal assemblies are arranged such that the force or load may be applied to anywhere on the pedal pad cover is detected. The pedal assemblies described herein include a linear bushing that has a large diameter and a centralized guide bore that acts as a vertical pillar extending from the pedal member to interact with a measurement subassembly assembly. Such an arrangement permits for a linear travel of the centralized guide pillar relative to the measurement subassembly regardless of where the force is applied on the pedal pad cover.

The measurement subassembly includes an inductive plate and a printed wiring assembly (PWA) that are configured, through induction, to sense the movement of the inductive plate, indicative of the amount of force or load applied anywhere on the pedal pad cover by utilizing force feedback techniques. Further, a wake-up switch is positioned within the measurement subassembly. The wake-up switch may include circuitry that is configured to send a signal or stop sending a signal to a sensing PWA and/or external electronic control unit (ECU), which in turn causes the sensing PWA and/or ECU to wake up from an idle state into an operational state for power consumption savings.

As used herein, the term “communicatively coupled” means that coupled components are capable of exchanging data signals with one another such as, for example, electrical signals via conductive medium or a non-conductive medium, though networks such as via Wi-Fi, Bluetooth, and the like, electromagnetic signals via air, optical signals via optical waveguides, and the like.

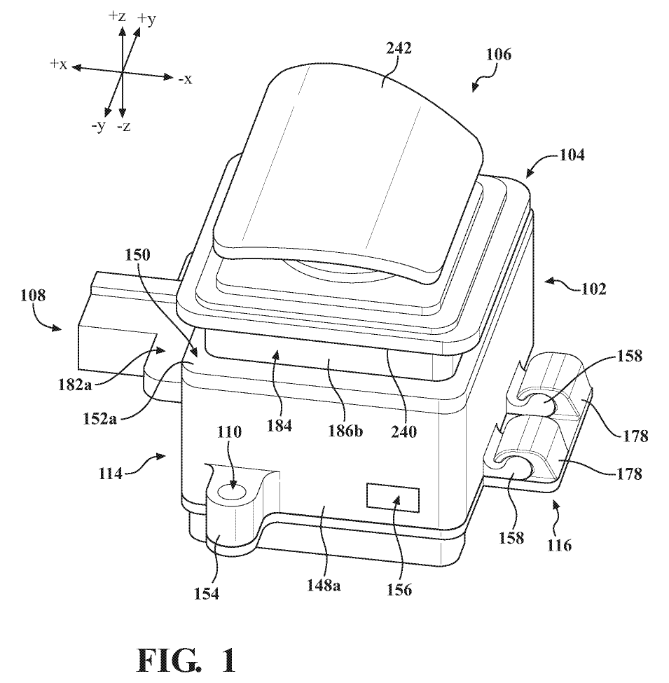

As used herein, the term “assembly lateral direction” refers to the cross-direction of the system (i.e., in a +/- Y direction of the coordinate axes depicted in FIG. 1). The term “assembly longitudinal direction” refers to the forward-rearward direction (i.e., along the +/- X axis of the coordinate axes depicted in FIG. 1), and is transverse to the lateral direction. The term “assembly vertical direction” refers to the upward-downward direction of the system (i.e., in the +/- Z direction of the coordinate axes depicted in FIG. 1).

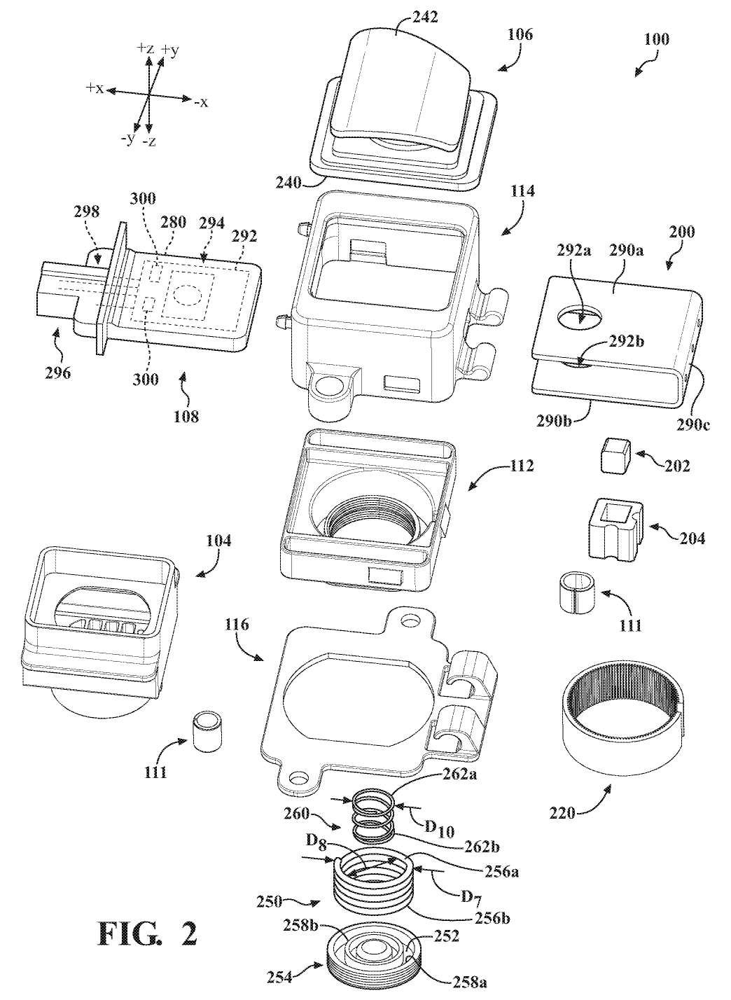

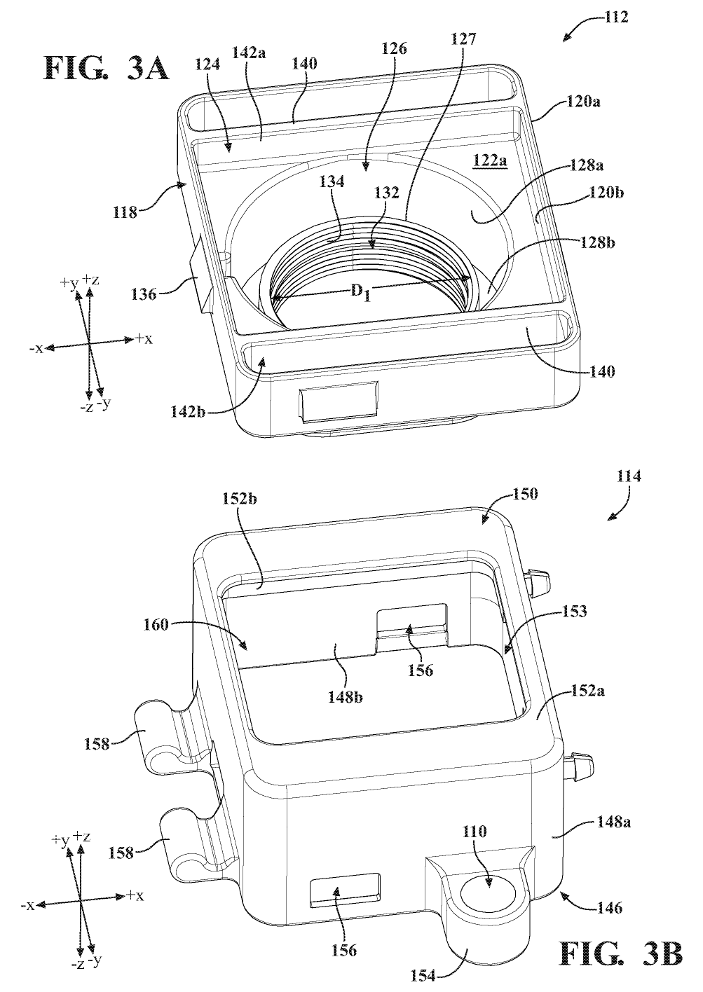

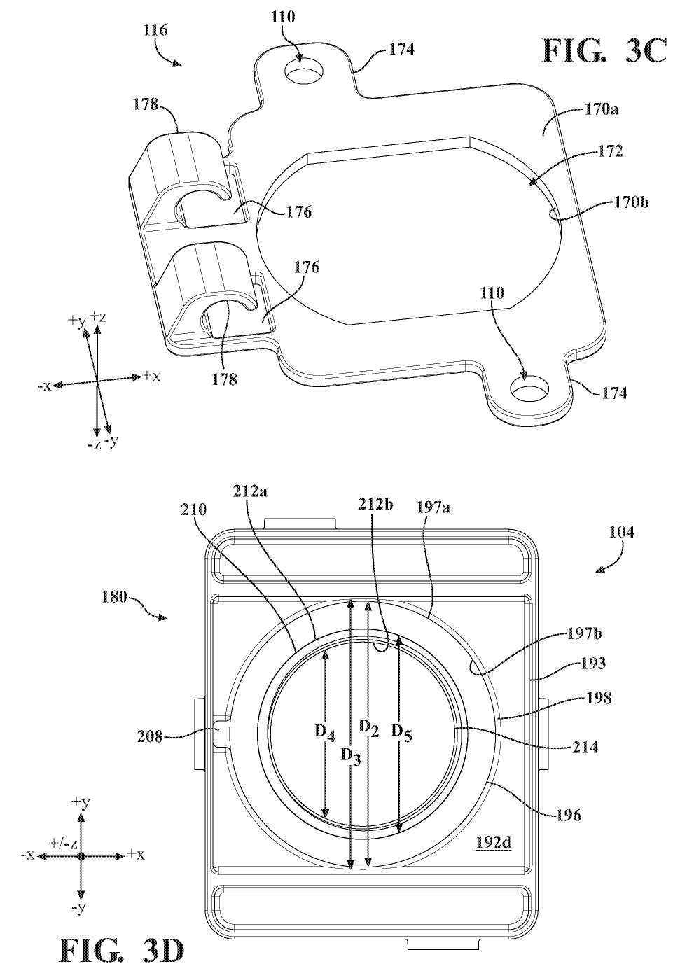

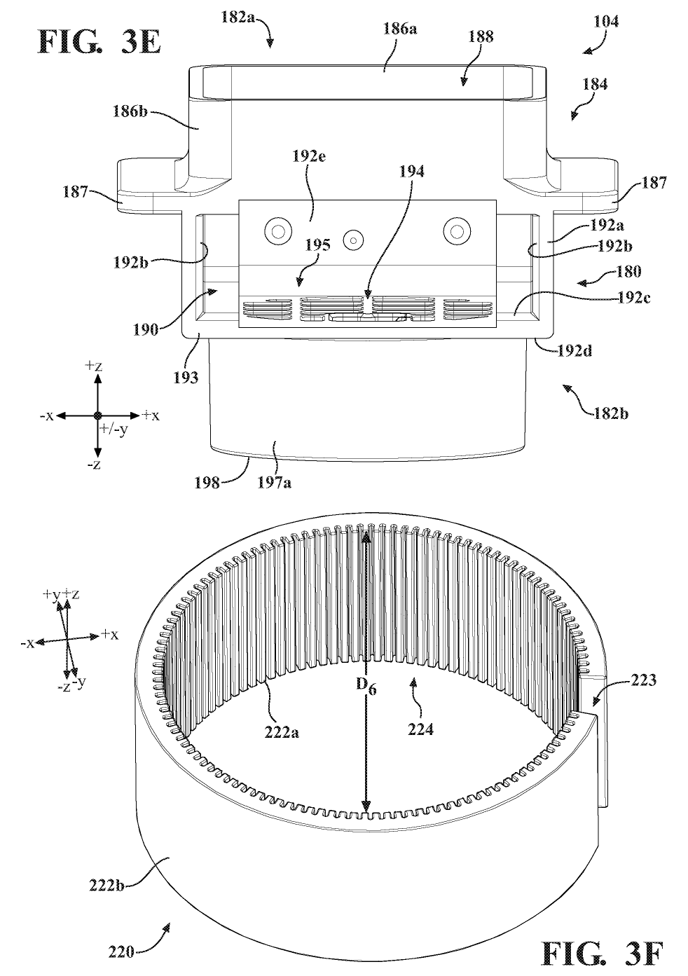

Now referring to FIGS. 1-4B, an example pedal assembly 100 is schematically depicted. The pedal assembly 100 may include a housing 102, a pedal member 104, a pedal cover 106, and a sensing assembly 108. The housing 102 may be configured to removably mount to an external surface or other vehicle components, such as, but not limited, to a floorboard of a vehicle. The housing 102 may be configured to mount to the external surface through a plurality of mounting apertures 110, each of the plurality of mounting apertures 110 sized to receive at least one fastener. For example, and without limitation, each of the plurality of mounting apertures 110 may receive a screw, rivet, bolt, adhesive, weld, hook and loop, and/or the like. Furthermore, each of the plurality of mounting apertures 110 may receive a compression member 111.

The housing 102 may be comprised of different sub assembly components, that when assembled, form or define the housing 102. The housing 102 may include a bottom housing member 112, an upper housing member 114, and a plate member 116. The bottom housing member 112 may include a continuous wall 118 that defines an outer surface 120a and an opposite inner surface 120b that that extends in the assembly vertical direction (i.e., in the +/- Z direction) from an interior surface 122a opposite an exterior surface 122b to define a cavity 124. Positioned within the cavity 124 and extending from the interior surface 122a surface is a continuous wall indention 126 defined by an inner surface 128a and a floor surface 128b. The continuous wall indention 126 forms a lip 127 circumferential surrounding a bore 132 and the floor surface 128b may be separated from other positions of the cavity 124 by a pair of upright right walls 140 that extend in the vertical direction (i.e., in the +/- Z direction) from the interior surface 122a. Each of the pair of upright right walls 140 include a pedal contact surface 142a and an opposite cavity surface 142b. As discussed in greater detail herein, in an assembled state, a distal portion of the pedal member 104 is configured to movably engage with the pedal contact surface 142a and the inner surface 120b of the continuous wall 118.

A protrusion portion 130 extends from the exterior surface 122b in the vertical direction (i.e., in the +/- Z direction) and includes the bore 132 extending therethrough with an inner diameter D1. Portions of the bore 132 are a threaded portion 134 that is configured to receive a complimentary thread, as discussed in greater detail herein. Further, as expected, the bore 132 is open at the lowermost portions in the assembly vertical direction (i.e., in the +/- Z direction) of the exterior surface 122b to provide access to the bore 132, the threaded portion 134, and the cavity 124, as discussed in greater detail herein. In some embodiments, the outer surface 120a may include tab members 136 extending therefrom and are configured to engage with the upper housing member 114 to releasably couple the bottom housing member 112 and the upper housing member 114, as discussed in greater detail herein.

The upper housing member 114 includes a continuous cover side wall portion 146 defined by an exterior surface 148a and an opposite interior surface 148b and a top wall portion 150 defined by a top wall exterior surface 152a and an opposite top wall interior surface 152b that form a receiving void 153. A pair of ears 154 extend from the exterior surface 148a of the continuous cover side wall portion 146 and are each configured to include the mounting apertures 110 for mounting of the example pedal assembly 100 to the vehicle, as discussed above. Further, the exterior surface 148a of the continuous cover side wall portion 146 includes receiving slots 156 that are configured to receive and engage with the tab members 136 of the bottom housing member 112 to releasably couple or otherwise attach the bottom housing member 112 to the upper housing member 114 when the bottom housing member 112 is assembled into or at least partially received into the receiving void 153, as discussed in greater detail herein. Further, a portion of the exterior surface 148a of the continuous cover side wall portion 146 may include

The top wall portion 150 includes an opening 160 that provides access to receiving void 153. The opening 160 of the top wall portion 150 may have a smaller area that that of the receiving void 153 such that portions of the top wall portion 150 cover or occlude portions of the receiving void 153. The opening 160 may be sized and shaped to receive and/or retain portions of the pedal member 104, as discussed in greater detail herein.

The plate member 116 includes a plate member inner surface 170a opposite a plate member outer surface 170b. An opening 172 extends between the plate member inner surface 170a and the plate member outer surface 170b. The opening 172 is sized and shaped to receive portions of protrusion portion 130 of the bottom housing member 112. The plate member 116 includes a pair of ears 174 that include the mounting apertures 110 that correspond to the ears 154 of the upper housing member 114. A pair of receiving hinge members 178 extend from the plate member inner surface 170a in the assembly vertical direction (i.e., in the +/- Z direction) and a pair of cutouts 176 are positioned below the pair of receiving hinge members 178 in the assembly vertical direction (i.e., in the +/- Z direction). In some embodiments, the pair of cutouts 176 are offset from the pair of receiving hinge members 178. In other embodiments, the pair of cutouts 176 are aligned with the pair of receiving hinge members 178. Each of the pair of receiving hinge members 178 are configured to receive a corresponding one of the pair of hinge members 158 of the upper housing member 114 to movably couple, via a hinge, the upper housing member 114 to the plate member 116 and such that the upper housing member 114 moves with respect to the plate member 116.

In the assembled position, portions of protrusion portion 130 of the bottom housing member 112 are received by the opening 172 such that the exterior surface 122b of the bottom housing member 112 abuts, is in contact with, and/or is adjacent to the plate member inner surface 170a.

The pedal member 104 includes a body 180 defined by an upper portion 182a and a lower portion 182b. The upper portion 182a includes a continuous pedal wall 184 that includes an inner surface 186a and an opposite outer surface 186b, a pedal floor surface 186c, and a pair of flanges 187 extending from the outer surface 186b. The inner surface 186a, the outer surface 186b, and the pedal floor surface 186c of the continuous pedal wall 184 together define an upper portion cavity 188. An elongated slot 190 is positioned in the body 180 below the upper portion cavity 188 in the vertical direction (e.g., in the +/- Z direction). The pedal floor surface 186c of the upper portion cavity 188 may define an upper wall surface 192a of the elongated slot 190 along with a pair of sidewalls surfaces 192b and a lower wall 193 that includes the lower wall surface 192c and a rear wall surface 192e. Further, the lower wall surface 192c and the upper wall surface 192a may include grooves 195, channels, or recesses, respectively, to receive an inductive plate 200 of the sensing assembly 108, as discussed in greater detail herein. The lower wall surface 192c may include a recess 194 that is configured to receive a target 202 and/or a target holder 204 of the sensing assembly 108, as discussed in greater detail herein.

A compressible member continuous wall 196 extends from an outer surface 192d of the lower wall 193 of the elongated slot 190 in the assembly vertical direction (i.e., in the +/- Z direction). The compressible member continuous wall 196 may be cylindrical in shape with an outer surface 197a and an opposite inner surface 197b and terminate at a terminating surface 198 with an inner diameter D2 and an outer diameter D3. A portion of the compressible member continuous wall 196 may be keyed 208 or have a protrusion extending therefrom. Positioned within the inner diameter D3 is a second compressible member continuous wall 210 that may be cylindrical in shape with an outer surface 212a and an opposite inner surface 212b and terminate at a terminating surface 214 with an inner diameter D4 and an outer diameter D5. In some embodiments, the terminating surface 198 terminated at a distance greater from the outer surface 192d of the lower wall 193 than the terminating surface 214. In other embodiments, the terminating surface 198 and the terminating surface 214 may terminate at an equal distance from the outer surface 192d of the lower wall 193.

The outer diameter D3 of the compressible member continuous wall 196 is smaller than the inner diameter D1 of the bore 132. As such, in the assembled state, portions of the compressible member continuous wall 196 are received within the bore 132, as discussed in greater detail herein. Further, each of the compressible member continuous wall 196 and the second compressible member continuous wall 210 are concentrically aligned. In some embodiments, the bore 132, the compressible member continuous wall 196, and the second compressible member continuous wall 210 are concentrically aligned.

The pedal cover 106 includes a coupling flange portion 240 opposite a pedal pad portion 242. The coupling flange portion 240 is sized and shaped to be received into the upper portion cavity 188 of the pedal member 104 such that the inner surface 186a of the continuous pedal wall 184 abuts or otherwise is in a snap-fit configuration with the coupling flange portion 240 of pedal cover 106.

In some embodiments, each components of the pedal member 104, the pedal cover 106, the bottom housing member 112, the upper housing member 114, and/or the plate member 116 may be independent monolithic structures formed as a single structure. In other embodiments, components or portions of the pedal member 104, the pedal cover 106, the bottom housing member 112, the upper housing member 114, and/or the plate member 116 may be coupled or otherwise attached together via at least one fastener. Example fasteners include, without limitation, bolt and nut, screw, rivet, weld, adhesive, epoxy, and/or the like.

The pedal member 104, the pedal cover 106, the bottom housing member 112, the upper housing member 114, and/or the plate member 116, as well as any of the other portions or components of the pedal member 104, the pedal cover 106, the bottom housing member 112, the upper housing member 114, and/or the plate member 116 may be independently manufactured as separate components such as by using injection molding techniques, additive manufacturing, and/or the like, or may integrated with one another, i.e., may be a single monolithic structure that is formed together, such as by using injection molding techniques, additive manufacturing, and/or the like.

As used herein, “additive manufacturing” refers generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt base superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

A linear bushing 220 is provided within the within the bottom housing member 112 to be received within the continuous wall indention 126 defined by the inner surface 128a and the floor surface 128b such that the linear bushing 220 is retained by the lip 127 of the continuous wall indention 126 and abuts the inner surface 128a and the floor surface 128b. As such, the linear bushing circumferentially surrounds the bore 132. The linear bushing includes a bushing interior surface 222a and an opposite exterior surface 222b and may have a keyway 223 configured to receive the key 208. A plurality of vertical grooves 224 may extend from the bushing interior surface 222a. that are configured to slidably engage with the outer surface 197a of the compressible member continuous wall 196 when the pedal member 104 moves, as discussed in greater detail herein. As such, the linear bushing 220 is generally cylindrical in shape and has an inner diameter D6 that is larger than the inner diameter D1 of the bore 132 and larger than the outer diameter D3 of the compressible member continuous wall 196 to be received within the inner diameter D6 of the linear bushing 220.

A first biasing member 250 is configured to extend between the outer surface 192d of the lower wall 193 at a first terminating end 256a and an inner surface 252 of a threaded member 254 at an opposite second terminating end 256b. The threaded member includes a plurality of treads that are configured to interact with the threaded portion 134 of the bore 132 of the bottom housing member 112 to removably attached the threaded member 254 to the housing 102. The first biasing member 250 may define an outer diameter D7 that is smaller than the inner diameter D2 but larger than the outer diameter D5 such that the first terminating end 256a is circumneutral surrounded by the compressible member continuous wall 196 but that also circumferentially surrounds the second compressible member continuous wall 210. Similarly, the inner surface 252 of the threaded member includes a pair of continuous walls 258a, 258b that are dimensional similar to the compressible member continuous wall 196 and the second compressible member continuous wall 210 to receive the second terminating end 256b and to maintain the linear positioning and spacing of the first biasing member 250.

A second biasing member 260 is configured to extend between the outer surface 192d of the lower wall 193 at a first terminating end 262a and the inner surface 252 of a threaded member 254 at an opposite second terminating end 262b. The second biasing member 260 may define an outer diameter D10 that is smaller than the inner diameter D8 of the first biasing member 250 to be positioned within and the inner diameter of the first biasing member 250. In this arrangement, both the first biasing member 250 and the second biasing member 260 may be co-axially aligned.

As such, the first biasing member 250 and the second biasing member 260 may define a two stage assembly where the second biasing member 260 may be configured to use with he wake-up switch sensor components, such as the wake-up switch subassembly 284, as discussed in greater detail herein. The first biasing member 250 may be configured for a return force. In a non-limiting example, the first biasing member 250 may be a brake force spring with 250 Newtons at 5 millimeters travel, and the second biasing member 260 may be a wake-up spring with 15 Newtons at 2 millimeters.

The outer diameter D10 of the second biasing member 260 may be less than the inner diameter D4 of the second compressible member continuous wall 210 such that the first terminating end 262a abuts with the outer surface 192d within the inner diameter D4 of the second compressible member continuous wall 210 such that the second compressible member continuous wall 210 circumferentially surrounds the first terminating end 262a. Similarly, the pair of continuous walls 258a, 258b of the threaded member 254 are dimensional similar to the compressible member continuous wall 196 and the second compressible member continuous wall 210 to receive the second terminating end 262b and to maintain the linear positioning and spacing of the second biasing member 260.

The threaded member 254 is configured to be movably threaded onto the threaded portion 134 of the bore 132 to adjust an initial force generated from the first biasing member 250 and/or the second biasing member 260. As such, the threaded member 254 may be a force adjuster that closes the bore 132 from outside contaminants and provides adjustability of the initial forces generated by the first biasing member 250 and/or the second biasing member 260. That is, as the threaded member 254 is rotated, it changes a compression force generated by the first biasing member 250 and/or the second biasing member 260 and thus can tune a force constant of the first biasing member 250 and/or the second biasing member 260 (e.g., stiffness and initial contact force control) of each of the first biasing member 250 and/or the second biasing member 260. In s non-limiting example, the first biasing member 250 and/or the second biasing member 260 may be a spring that is known to have a force, F = kx, where k=spring constant. The spring constant k may now be controlled or otherwise adjusted by movement of the threaded member 254 moving up and down within the bore 132 in the assembly vertical direction (e.g., in the +/- Z direction). As such, this arrangement permits for a customizable dial in and dial out to control the stiffness and initial contact force control in a non-limiting way that the smaller free height, the stiffer is the spring.

In some embodiments, the first biasing member 250 and/or the second biasing member 260 may be formed of any material that may be configured to exhibit a bias towards returning to an original pre-stressed shape, such as, but not limited to, a spring, rubber, silicone, or any other elastic and compressible material or configuration known in the art. Accordingly, each of the first biasing member 250 and/or the second biasing member 260 may operate to provide a force that may be felt by the driver and/or return the pedal cover 106 into a home position (e.g., position without any load applied thereon).

The sensing assembly 108 may include a measurement subassembly 278 that includes the inductive plate 200 and a printed wiring assembly 280. The sensing assembly 108 may further include a sensing housing 282 and a wake-up switch subassembly 284, which may include at least the target 202, the target holder 204 and/or the second biasing member 260.

The target 202 is positioned within the target holder 204 and may be at least partially received by the recess 194 of the pedal member 104, which is positioned below the inductive plate 200 in the assembly vertical direction (i.e., in the +/- Z direction). The inductive plate 200 includes a pair of arms 290a, 290b connected by a base 290c to generally form a "U" shape. Each of the pair of arms 290a, 290b include an aperture 292a, 292b, respectively. In the assembled state, the inductive plate 200 is housed within the elongated slot 190 in such a position that the base 290c may abut the rear wall surface 192e, the arm 290a may abut the upper wall surface 192a and the arm 290b may abut the lower wall surface 192c within the respective grooves 195 such that the aperture 292b is coaxially aligned with the target 202 and the target holder 204, as discussed in greater detail herein. Each of the arms 290a, 290b are separated by a distance of the base 290c, which is large enough to accommodate at least a portion of the printed wiring assembly 280.

The printed wiring assembly 280 may include a circuit board 292 (or a printed circuit board), at least one coil 294, a connector housing 296, and a plurality of terminal pins 298 positioned within the connector housing 296 and extending from the circuit board 292. In the assembled state, the at least one coil 294 is positioned within the space between the pair of arms 290a, 290b at a predetermined distance from at least one of the arms 290a, 290b without a load applied to the pedal cover 106. This permits for a known inductance between the inductive plate 200 and the at least one coil 294 at the home position of the pedal cover 106 (e.g., no load).

In operation, the at least one coil 294 is configured to detect movement of the inductive plate 200 via change in inductance. When a load is applied to the pedal cover 106, the pedal member 104 move in the assembly vertical direction (i.e., in the +/- Z direction) thereby moving the inductive plate 200. Because the printed wiring assembly 280 (e.g., the at least one coil 294) is fixed in position and the inductive plate 200 moves relative to the printed wiring assembly 280, a change in inductance is detected.

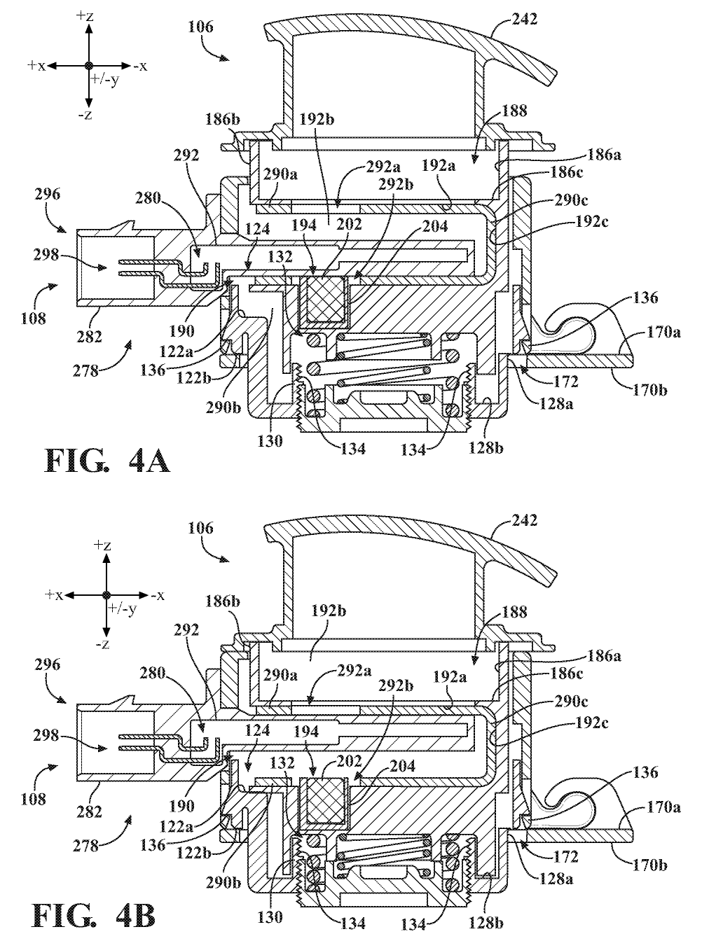

As such, when the pedal member 104 moves, the inductive plate 200 also moves in the vertical direction against the first and second biasing members 250, 260, increasing a spacing or distance between the at least one coil 294 and the arm 290b of the inductive plate 200 and decreasing a distance between the at least one coil 294 and the arm 290a of the inductive plate 200, as best illustrated in FIGS. 4A, which depicts a no load state (e.g., no force or load applied to the pedal cover 106), and FIG. 4B, which depicts a load state (e.g., a force or a load is applied to the pedal cover 106).

That is, the at least one coil 294 is configured to sense any changes in inductance between the at least one coil 294 and the inductive plate 200, which is indicative of movement of the inductive plate 200, thereby changing the distance between the inductive plate 200 and the at least one coil 294, and changing the inductance therebetween. Based on the amount of change in the inductance, the at least one coil 294 may transmit signals to an external electronic control unit via the plurality of terminal pins 298 through a vehicle side connector communicatively coupled to the plurality of terminal pins 298 positioned within the connector housing 296 to a vehicle side electronic control unit and/or powertrain controller, or may use an electronic control unit of the pedal assembly to determine an amount of load applied to the pedal cover 106 and transmit the determined data via the plurality of terminal pins 298 through a vehicle side connector communicatively coupled to the plurality of terminal pins 298 positioned within the connector housing 296 to the vehicle side electronic control unit and/or powertrain controller. As such, using inductive principles, a change in the inductance between the inductive plate 200 and the at least one coil 294 is determined and the inductance change is translated into an electrical signal.

The circuit board 292 of the printed wiring assembly 280 may further include at least one sensor 300 configured to detect movement of the target 202. When a load is applied to the pedal cover 106, the pedal moves in the assembly vertical direction (i.e., in the +/- Z direction) thereby moving the inductive plate 200. In some embodiments, the target 202 and the printed wiring assembly 280 are each fixed into position and the inductive plate 200 moves relative to the target 202 and the printed wiring assembly 280. As such, when the inductive plate 200 moves, portions of the target 202 may be received within the aperture 292b of the inductive plate 200 thereby permitting the inductive plate 200 and the pedal member 104 to move in the vertical direction against the biasing members, increasing a spacing or distance between the at least one sensor 300 and the target 202.

The at least one sensor 300 may be positioned adjacent or co-axially with the target 202 when the target 202 is in the home position (e.g., no load on the pedal cover 106 in FIG. 4A). As such, any load applied to the pedal cover 106 (FIG. 1) would move the pedal member 104 and the inductive plate 200, thereby changing a magnetic field strength at the at least one sensor 300, indicative of movement of the pedal member 104.

The target 202 may be magnet with a plurality of shapes, such as rectangular, square, hexagonal, octagonal, and/or the like. The at least one sensor 300 may be at least one Hall effect chip that is sensitive to a Hall effect detection of magnetic change. As such, the at least one sensor 300 may be configured to detect changes in magnetic field strength, indicative of movement of the target 202 by sensing changes in the in-plane magnetic field components. Further, the at least one sensor 300 may act as a switch that is configured to detect the magnetic field strength generated by the target 202 such that when there is a change in the magnetic field, the at least one sensor 300 may either initiate a first signal to a vehicle side electronic control unit or inhibits (e.g., stops) the transmitting of a second signal to the vehicle side electronic control unit. The receiving of the first signal or the stopping of the second signal is an indication to the vehicle side electronic control unit to wake-up other electronics that are switched from a powered off state now into a powered on state, for electrical savings.

In some embodiments, portions of the sensing housing 282 may be formed from an overmolded to encapsulate and protect the one or more sensor components and may be used to couple the sensing assembly 108 to the pedal member 104. That is, the sensing housing 282 may further include a plurality of resilient members configured to engage with the pedal member 104 or may include bores that are configured to receive fasteners to couple the sensing housing 282 to the pedal member 104. Example fasteners include, without limitation, a screw, bolt and nut, rivet, adhesive, weld, epoxy, hook and loop, and/or the like.

It should be understood that the sensing assembly 108 utilizes different sensing technologies to simultaneously measure the movement of the pedal cover 106.

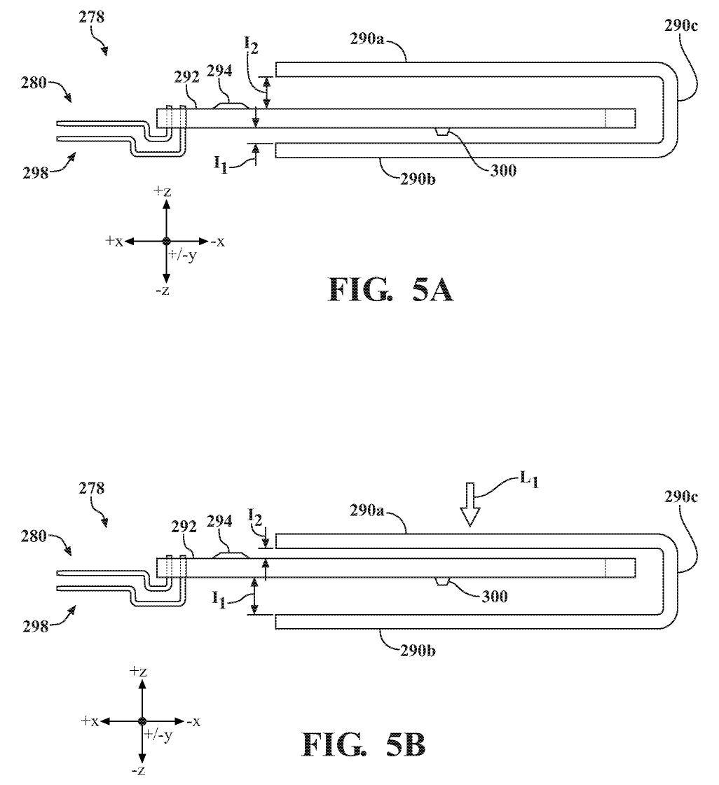

Now referring to FIGS. 5A-5B, an example isolated side view of the movement of the inductive plate 200 relative to the printed wiring assembly 280 is schematically depicted. FIG. 5A illustrates that in a no load state, the distance between the arm 290b and the circuit board (e.g., the at least one coil 294), depicted by I1 is less than the distance between the arm 290a and the circuit board 292 (e.g., the at least one coil 294) depicted by I2. In operation, when the load is applied to the pedal cover 106, (e.g., in a load applied state), the load drives the pedal member 104 against the first and second biasing members 250, 260 and moves not lonely the pedal member 104, but also the inductive plate 200 housing within the elongated slot 190 of the pedal member 104. As such, as depicted in FIG. 5B, the load, indicated by arrow L1, changes the distance I2 between the arm 290a and the circuit board 292 and the distance I1 between the arm 290b and the circuit board 292. This change in distance (e.g., the gap between the circuit board 292 and the arm 290a depicted by distance I2 is now smaller with the load L1 applied) changes an inductance between the inductive plate 200 and the at least one coil 294 in the load state. The change in inductance is measured and can be used to determine an amount of force or the load applied anywhere to the pedal pad portion 242.

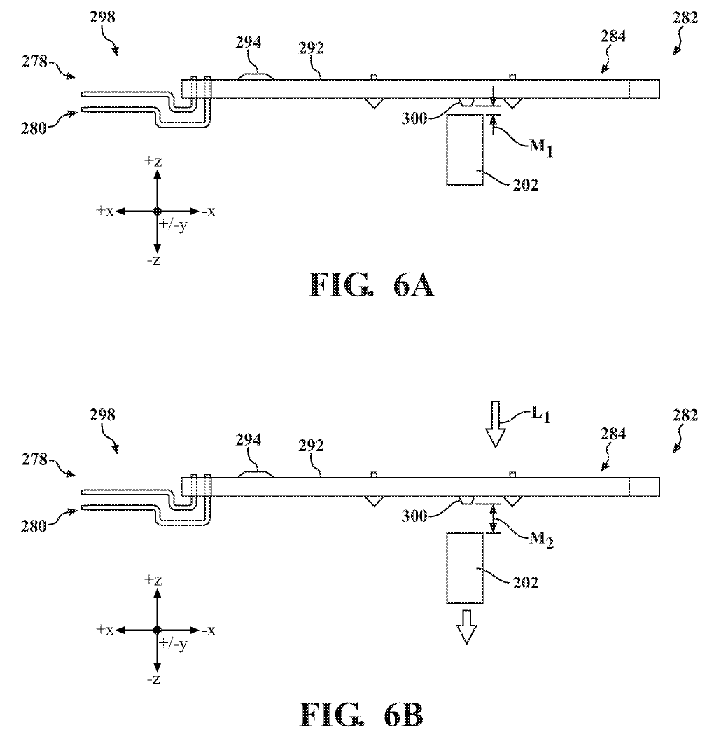

Now referring to FIGS. 6A-6B, an example isolated side view of the movement of the target 202 relative to the circuit board 292 and the at least one sensor 300 is schematically depicted. As depicted in FIG. 6A, a distance M1 between the at least one sensor 300 and the target 202 is in the no load state (e.g., without the load L1 applied to the pedal pad portion 242). In operation, when the load L1 is applied to the pedal cover 106, (e.g., in the load state), the load drives the pedal member 104 against the first and second biasing members 250, 260 and moves not only the pedal member 104, but also the target 202 positioned within the recess 194 of the elongated slot 190 of the pedal member 104. As such, as depicted in FIG. 6B, the load L1 changes the distance M2 between the target 202 and the at least one sensor 300. This change in distance (e.g., the gap between the at least one sensor 300 and the target 202 is now larger a distance M2) changes the magnetic field strength between the target 202 and the at least one sensor 300. The change in magnetic field strength can be used as a switch, as discussed above, indicates that the load L1 is applied anywhere to the pedal pad portion 242.

Now referring back to FIGS. 1-7, it should be appreciated that the example pedal assembly 100 described herein permits for sensing of a minimal travel of the pedal cover 106 relative to the housing 102 in which the load is detected no matter where the load is applied onto the pedal cover 106. The example pedal assembly 100 utilizes inductance, which can detect extremely small changes to the inductance, which is indicative that there is a load present on the pedal cover 106. In a non-limiting example, the total travel of the pedal member 104 and the pedal cover 106 is 5 millimeters. Therefore, slight or minimal travel needs to be detected. This is non-limiting and the total travel of the pedal member 104 and the pedal cover 106 may be less than 5 millimeters or greater than 5 millimeters. In another non-limiting example, the wake-up switch functioning may be detected by a movement of 2 millimeters. That is, at 2 millimeters or greater of movement, the wake-up switch activation may occur, as discussed in greater detail herein. This is non-limiting and the wake-up switch functioning may be detected at less than 2 millimeters or greater than 2 millimeters.

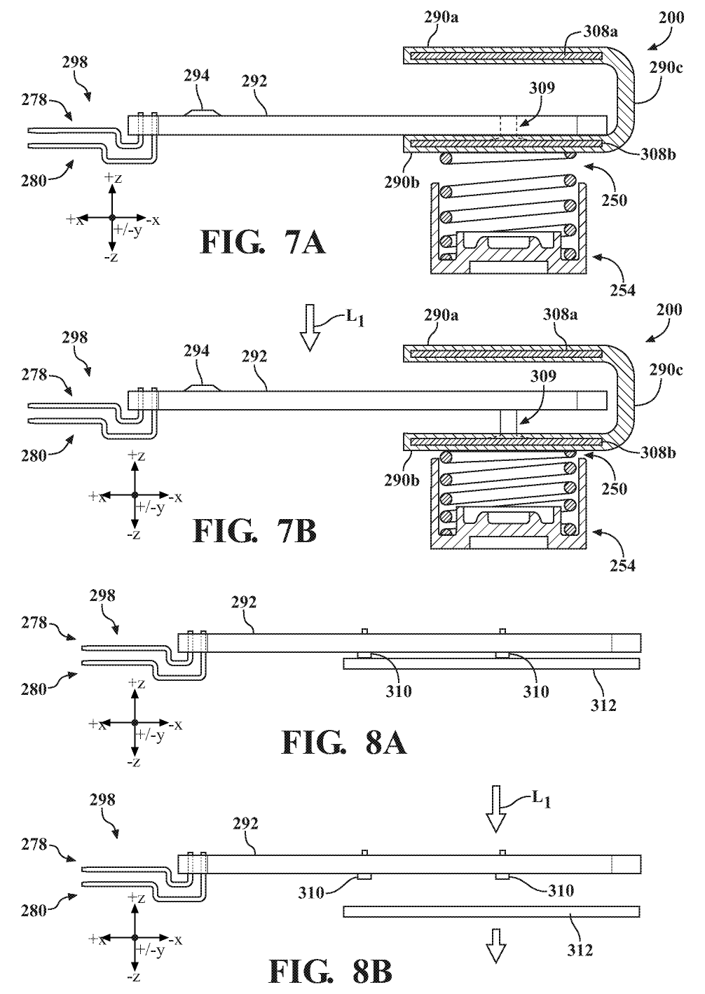

Now referring to FIGS. 7A-7B, an example isolated plan side view of a second example printed wiring assembly for the wake-up switch is depicted. The inductive plate 200 may now include a pair of additional plate or a layer of conductive plates 308a, 308b encased, embedded, or positioned as part of the inductive plate 200 with a pair of spring elements 309 extending therefrom. As depicted in FIG. 7A, in a no load state (e.g., no load applied to the pedal cover 106), the spring elements 309 extend from the conductive plates 308a, 308b to be in contact with the printed wiring assembly 280. This contact permits or inhibits a current to pass, which is indicative that there is not a load applied to the pedal cover 106 and thus the need for the wake-up switch to initiate the power-on requirement is not required.

Conversely, as depicted in FIG. 7B, in the load applied state, because of the movement of the inductive plate 200, each of the pair of spring members 309 are no longer in contact with the printed wiring assembly 280 creating an open circuit. As such, now the opposite condition exists (e.g., from permitting the current to pass to now inhibiting the current to pass). Based on the changed state of the current, such as for example and without limitation, a short circuit, this is indicative that there is a load applied to the pedal cover 106 and thus the need for the wake-up switch to initiate the power-on requirement is now required. In response, either a transmitting of the first signal or the stopping of the second signal is performed an indication to the vehicle side electronic control unit to wake-up other electronics that are switched from the powered off state now into the powered on state, for electrical savings.

Now referring to FIGS. 8A-8B, an example isolated plan side view of a third example printed wiring assembly for the wake-up switch is depicted. In this aspect, the printed wiring assembly may include at least one contact point 310 extending therefrom and configured to interact with at least one wake-up plate 312. In the no load state, the wake-up circuit is closed and there is direct contact between the at least one contact point 310 the at least one wake-up plate 312, as best illustrated in FIG. 8A. As the load is applied L1, in the load state, the at least one wake-up plate 312 moves away from the at least one contact point 310 thus breaking the circuit, as best illustrated in FIG. 8B. In response, either a transmitting of the first signal or the stopping of the second signal is performed an indication to the vehicle side electronic control unit to wake-up other electronics that are switched from the powered off state now into the powered on state, for electrical savings.

In some embodiments, the at least one contact point 310 may be a pair of contact points positioned on each side of the circuit board 292 and the at least one wake-up plate 312 is a pair of plates positioned above and below the circuit board 292 in the assembly vertical direction (i.e., in the +/- Z direction). This arrangement provides for redundancy in the case that there is not a true linear travel.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is also noted that recitations herein of “at least one” component, element, etc., should not be used to create an inference that the alternative use of the articles “a” or “an” should be limited to a single component, element, etc.

It is noted that recitations herein of a component of the present disclosure being "configured" or “programmed” in a particular way, to embody a particular property, or to function in a particular manner, are structural recitations, as opposed to recitations of intended use.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### ASPECTS LISTING

Aspect 1. A pedal assembly including a housing, a pedal member movably positioned within the housing, and a sensing assembly positioned within the housing, the sensing assembly including: an inductive plate having a pair of arms connected by a base forming a "U" shape, and a printed wiring assembly positioned at least partially within an opening between the pair of arms, the printed wiring assembly spaced apart from the pair of arms by a predetermined distance and configured to generate an inductance between the printed wiring assembly and the inductive plate, wherein when a load is applied on the pedal member, the predetermined distance between each of the pair of arms changes based on an amount of the load applied, causing a change in the inductance based on the amount of the load applied to the pedal sensed by the sensing assembly.

Aspect 2. The pedal assembly of Aspect 1 wherein the pedal member includes an elongated slot that is configured to receive the inductive plate.

Aspect 3. The pedal assembly of any of Aspect 1 to Aspect 2, wherein the pedal member includes a bottom surface having a pair of spaced apart continuous walls that are concentrically aligned.

Aspect 4. The pedal assembly of any of Aspect 1 to Aspect 3, further including a linear bushing having an interior surface and an opposite exterior surface, the interior surface having a plurality of grooves that are configured to engage with an outermost continuous wall of the pair of spaced apart continuous walls.

Aspect 5. The pedal assembly of any of Aspect 1 to Aspect 4, wherein the housing is a two part arrangement having a bottom housing member and an upper housing member.

Aspect 6. The pedal assembly of any of Aspect 1 to Aspect 5, wherein the bottom housing member includes a centralized bore configured to receive at least portions of the linear bushing and a portion of the pair of spaced apart continuous walls to guide the pedal member in a vertical direction.

Aspect 7. The pedal assembly of any of Aspect 1 to Aspect 6, wherein a portion of the centralized bore is threaded.

Aspect 8. The pedal assembly of any of Aspect 1 to Aspect 7, further including a threaded member configured to be assembled to the bottom housing member at a threaded portion and a biasing member extending between the threaded member and the bottom surface of the pedal member within an inner diameter of the linear bushing, wherein the threaded member is configured to be moved in the vertical direction via the threaded portion of the bottom housing member to change a force of the biasing member.

Aspect 9. The pedal assembly of any of Aspect 1 to Aspect 8, further including a second biasing member extending between the threaded member and the bottom surface of the pedal member within the inner diameter of the linear bushing, wherein the threaded member is configured to be moved in the vertical direction via the threaded portion of the bottom housing member to change a force of the second biasing member.

Aspect 10. The pedal assembly of any of Aspect 1 to Aspect 9, wherein the upper housing member of the housing includes a cavity configured to receive an upper surface of the bottom housing member in an assembled state.

Aspect 11. The pedal assembly of any of Aspect 1 to Aspect 10, wherein the sensing assembly further includes a target positioned within the housing at a target predetermined distance from the printed wiring assembly, a sensor communicatively coupled to the printed wiring assembly and configured to detect a change in the target predetermined distance, wherein when the load is applied on the pedal, the target predetermined distance changes causing the sensor to either output a change signal or stop transmitting a signal.

Aspect 12. A pedal assembly including a housing, a pedal member movably positioned within the housing, the pedal member having an elongated slot, and a sensing assembly positioned within the housing, the sensing assembly including: an inductive plate having a pair of arms connected by a base forming a "U" shape, the inductive plate positioned within the elongated slot of the pedal, and a printed wiring assembly positioned at least partially within an opening between the pair of arms and partially within the elongated slot of the pedal, the printed wiring assembly spaced apart from the pair of arms by a predetermined distance and configured to generate an inductance between the printed wiring assembly and the inductive plate, a target positioned within the housing at a target predetermined distance from the printed wiring assembly; and a sensor communicatively coupled to the printed wiring assembly and configured to detect a change in the target predetermined distance, wherein when a load is applied on the pedal, the predetermined distance between each of the pair of arms changes based on an amount of the load applied, causing a change in the inductance based on the amount of the load applied to the pedal sensed by the sensing assembly and the target predetermined distance changes causing the sensor to either output a change signal or stop transmitting a signal.

Aspect 13. The pedal assembly of Aspect 12, wherein the pedal member includes a bottom surface having a pair of spaced apart continuous walls that are concentrically aligned.

Aspect 14. The pedal assembly of any of Aspect 12 to Aspect 13 further including a linear bushing having an interior surface and an opposite exterior surface, the interior surface having a plurality of grooves that are configured to engage with an outermost continuous wall of the pair of spaced apart continuous walls.

Aspect 15. The pedal assembly of any of Aspect 12 to Aspect 14, wherein the housing is a two part arrangement having a bottom housing member and an upper housing member.

Aspect 16. The pedal assembly of any of Aspect 12 to Aspect 15, wherein the bottom housing member includes a centralized bore configured to receive at least portions of the linear bushing and a portion of the pair of spaced apart continuous walls to guide the pedal member in a vertical direction.

Aspect 17. The pedal assembly of any of Aspect 12 to Aspect 16, wherein a portion of the centralized bore is threaded.

Aspect 18. The pedal assembly of any of Aspect 12 to Aspect 17, further including a threaded member configured to be assembled to the bottom housing member at a threaded portion, and a biasing member extending between the threaded member and the bottom surface of the pedal member within an inner diameter of the linear bushing, wherein the threaded member is configured to be moved in the vertical direction via the threaded portion of the bottom housing member to change a force of the biasing member.

Aspect 19. The pedal assembly of any of Aspect 12 to Aspect 18, further including a second biasing member extending between the threaded member and the bottom surface of the pedal member within the inner diameter of the linear bushing, wherein the threaded member is configured to be moved in the vertical direction via the threaded portion of the bottom housing member to change a force of the second biasing member.

Aspect 20. The pedal assembly of any of Aspect 12 to Aspect 19 wherein the upper housing member of the housing includes a cavity configured to receive an upper surface of the bottom housing member in an assembled state.

Aspect 22. The pedal assembly of any of Aspect 1 to Aspect 21.

Aspect 23. A method including any combination of features of any of Aspects 1 to Aspect 22.

1. A pedal assembly comprising:
a housing;
a pedal movably positioned within the housing; and
a sensing assembly positioned within the housing, the sensing assembly including:
an inductive plate having a pair of arms connected by a base forming a "U" shape in cross-section; and
a printed wiring assembly positioned at least partially within an opening between the pair of arms, the printed wiring assembly spaced apart from the pair of arms by a predetermined distance and configured to generate an inductance between the printed wiring assembly and the inductive plate,
wherein when a load is applied on the pedal, the predetermined distance between each of the pair of arms changes based on an amount of the load applied, causing a change in the inductance based on the amount of the load applied to the pedal member sensed by the sensing assembly.

2. The pedal assembly of claim 1, wherein the pedal member includes an elongated slot that is configured to receive the inductive plate.

3. The pedal assembly of claim 1, wherein the pedal member includes a bottom surface having a pair of spaced apart continuous walls that are concentrically aligned.

4. The pedal assembly of claim 3, further comprising:
a linear bushing having an interior surface and an opposite exterior surface, the interior surface having a plurality of grooves that are configured to engage with an outermost continuous wall of the pair of spaced apart continuous walls.

5. The pedal assembly of claim 4, wherein the housing is a two part arrangement having a bottom housing member and an upper housing member.

6. The pedal assembly of claim 5, wherein the bottom housing member includes a centralized bore configured to receive at least portions of the linear bushing and a portion of the pair of spaced apart continuous walls to guide the pedal member in a vertical direction.

7. The pedal assembly of claim 6, wherein a portion of the centralized bore is threaded.

8. The pedal assembly of claim 7, further comprising:
a threaded member configured to be assembled to the bottom housing member at a threaded portion; and
a biasing member extending between the threaded member and the bottom surface of the pedal member within an inner diameter of the linear bushing,
wherein the threaded member is configured to be moved in the vertical direction via the threaded portion of the bottom housing member to change a force of the biasing member.

9. The pedal assembly of claim 8, further comprising:
a second biasing member extending between the threaded member and the bottom surface of the pedal member within the inner diameter of the linear bushing,
wherein the threaded member is configured to be moved in the vertical direction via the threaded portion of the bottom housing member to change a force of the second biasing member.

10. The pedal assembly of claim 5, wherein the upper housing member of the housing includes a cavity configured to receive an upper surface of the bottom housing member in an assembled state.

11. The pedal assembly of claim 1, wherein the sensing assembly further comprises:
a target positioned within the housing at a target predetermined distance from the printed wiring assembly;
a sensor communicatively coupled to the printed wiring assembly and configured to detect a change in the target predetermined distance,
wherein when the load is applied on the pedal, the target predetermined distance changes causing the sensor to either output a change signal or stop transmitting a signal.

12. A pedal assembly comprising:
a housing;
a pedal member movably positioned within the housing, the pedal member having an elongated slot; and
a sensing assembly positioned within the housing, the sensing assembly including:
an inductive plate having a pair of arms connected by a base forming a "U" shape, the inductive plate positioned within the elongated slot of the pedal; and
a printed wiring assembly positioned at least partially within an opening between the pair of arms and partially within the elongated slot of the pedal, the printed wiring assembly spaced apart from the pair of arms by a predetermined distance and configured to generate an inductance between the printed wiring assembly and the inductive plate;
a target positioned within the housing at a target predetermined distance from the printed wiring assembly; and
a sensor communicatively coupled to the printed wiring assembly and configured to detect a change in the target predetermined distance,
wherein when a load is applied on the pedal, the predetermined distance between each of the pair of arms changes based on an amount of the load applied, causing a change in the inductance based on the amount of the load applied to the pedal sensed by the sensing assembly and the target predetermined distance changes causing the sensor to either output a change signal or stop transmitting a signal.

13. The pedal assembly of claim 12, wherein the pedal member includes a bottom surface having a pair of spaced apart continuous walls that are concentrically aligned.

14. The pedal assembly of claim 13, further comprising:
a linear bushing having an interior surface and an opposite exterior surface, the interior surface having a plurality of grooves that are configured to engage with an outermost continuous wall of the pair of spaced apart continuous walls.

15. The pedal assembly of claim 14, wherein the housing is a two part arrangement having a bottom housing member and an upper housing member.

16. The pedal assembly of claim 15, wherein the bottom housing member includes a centralized bore configured to receive at least portions of the linear bushing and a portion of the pair of spaced apart continuous walls to guide the pedal member in a vertical direction.

17. The pedal assembly of claim 16, wherein a portion of the centralized bore is threaded.

18. The pedal assembly of claim 17, further comprising:
a threaded member configured to be assembled to the bottom housing member at a threaded portion; and
a biasing member extending between the threaded member and the bottom surface of the pedal member within an inner diameter of the linear bushing,
wherein the threaded member is configured to be moved in the vertical direction via the threaded portion of the bottom housing member to change a force of the biasing member.

19. The pedal assembly of claim 18, further comprising:
a second biasing member extending between the threaded member and the bottom surface of the pedal member within the inner diameter of the linear bushing,
wherein the threaded member is configured to be moved in the vertical direction via the threaded portion of the bottom housing member to change a force of the second biasing member.

20. The pedal assembly of claim 15, wherein the upper housing member of the housing includes a cavity configured to receive an upper surface of the bottom housing member in an assembled state.
